(19) United States
(12) Patent Application Publication
(10) Pub. No.: US 2013/0075324 A1
(43) Pub. Date: Mar. 28, 2013

(54) COMPOSITE POROUS FILM FOR FLUID SEPARATION, METHOD FOR MANUFACTURING THE SAME AND FILTER

(71) Applicants: Kazuyuki Sakamoto, Chiba (JP); Osamu Kojima, Chiba (JP); Osamu Yamaguchi, Chiba (JP)

(72) Inventors: Kazuyuki Sakamoto, Chiba (JP); Osamu Kojima, Chiba (JP); Osamu Yamaguchi, Chiba (JP)

(73) Assignees: JNC PETROCHEMICAL CORPORATION, TOKYO (JP); JNC CORPORATION, TOKYO (JP)

(21) Appl. No.: 13/698,979

(22) PCT Filed: Jun. 17, 2011
(86) PCT No.: PCT/JP2011/063884

§ 371 Date: Nov. 19, 2012

(30) Foreign Application Priority Data
Jun. 18, 2010 (JP) 2010-139688

(51) Int. Cl. B01D 71/04; B01D 67/00; B01D 69/08; B01D 69/06; B01D 71/32; B01D 71/30

(52) U.S. Cl. 210/500.23; 210/500.26; 427/244

(57) ABSTRACT

An objective of the invention disclosure is to provide a composite porous film that has both a sufficient chemical resistance and strength allowing suppression of heat deflection under a liquid at a high temperature, and a filter using the same; the composite porous film for fluid separation to be provided according to the invention includes a fluoropolymer resin and a SiO₂ glass.

### TECHNICAL FIELD

The present invention relates to a composite porous film for fluid separation. More specifically, the invention relates to a composite porous film for fluid separation, wherein the film is excellent in resistance to heat deflection and chemical resistance, and suitable as an application for a filter material, a method for manufacturing the same, and a filter using the same.

### BACKGROUND

A microporous film of polytetrafluoroethylene (PTFE) is excellent in chemical resistance and heat resistance, and thus is widely used as an air filter, a bag filter and a filter for liquid filtration. Specific examples of a process for manufacturing a PTFE microporous film include a method for mixing PTFE powder and a liquid lubricant to prepare paste, preparing a preform by extrusion molding of the paste, and then forming the resultant preform into a sheet material by a technique of extrusion and/or rolling or the like, and further stretching the sheet material at least uniaxially to obtain the PTFE microporous film.

The PTFE microporous film obtained according to such a technique has both a high chemical resistance having all of acid resistance, alkali resistance and organic solvent resistance, and heat resistance resulted from a high melting point and a continuously usable temperature (260° C., for example). Thus, the microporous film is an essential raw material upon filtering a high-temperature and highly-reactive cleaning chemical that is used particularly in a field of manufacture and cleaning of a semiconductor.

In a semiconductor manufacturing field in recent years, densification of a logic circuit is advanced rapidly in order to achieve a further high capacity of a memory, and a circuit half pitch (groove width) is also shortened as a result thereof. Therefore, a development has been required for a high-accuracy filter that can remove impurity particles micronized from a 100 nanometer size that has been required so far down to a 50 nanometer size to a 30 nanometer size for an impurity (particles) being a cause of pitch clogging.

A study has been conducted to achieve high-accuracy of the PTFE microporous film in developing the filter. Although a mean pore diameter of the PTFE microporous film that has been used so far has been a 50 nanometer size, a microporous film having a 30 nanometer size is now used due to a desire for achieving further high-accuracy. However, the filters constituted of the microporous film have been able to sufficiently respond to an impurity having an about 100 nanometer size. However, the filters have been quite difficult to ensure a sufficient filtration accuracy for an impurity having a size smaller than the above, in particular, an impurity having a level of 50 nanometers to 30 nanometers due to causes as described below, although the size has been in the mean pore diameter or more.

In a semiconductor cleaning step, a cleaning solution is circulated in a state in which the cleaning solution is kept at about 120° C. in order to efficiently remove a resist film and decompose particles or an organic impurity accompanying therewith. For example, in sulfuric acid hydrogen peroxide mixture (SPM) cleaning as one of cleaning steps, concentrated sulfuric acid and a hydrogen peroxide solution are mixed and kept at a high temperature to produce persulfuric acid (H₂SO₅) having a very strong oxidizing power, and to allow the persulfuric acid to significantly act on decomposition of the organic impurity. However, a heat deflection temperature of PTFE is about 115° C. In a situation in which a high-temperature fluid under such conditions is circulated, opening or deformation of a hole part is easily caused by filtration pressure applied during filtration or physical stress accompanied with other factors. Therefore, even with the microporous film having sufficiently guaranteed filtration accuracy for a fluid at normal temperature, keeping filtration accuracy is quite difficult for a fluid at a high temperature. In particular, the microporous film has a problem of quite difficulty in collecting impurity particles having a size close to the mean pore diameter.

Specific examples of a technique for solving the problems include achieving further high-accuracy of the PTFE microporous film. A filter labeled as a microporous film having a mean pore diameter of 15 nanometer size is partially distributed, and a trend of achieving high-accuracy is also progressing from now on.

Meanwhile, a technology for providing the microporous film with an additional function by covering a surface of the microporous film with an inorganic component is known. For example, such an art is disclosed as a silica gel composite polymer porous medium composed of a polymer microporous medium including continuous pores having a nominal mean pore diameter in the range of 0.02 to 15 micrometers, and silica gel for coating an internal surface of the pores of the porous medium, and a filter using the same (see Patent literature No. 1, for example).

A laminated composite film for gas separation is also disclosed, wherein low-temperature plasma treatment using a non-polymerizable gas is applied to a composite film for gas separation prepared by coating on a microporous support with a polymer material typified by polyolefins, vinyl polymers, conjugated diene polymers, polyethers, and polycondensates such as polydimethylsiloxane, and then a silicon-containing polymer is applied thereto to produce a film having an excellent gas permeability, and an improved gas selectivity and durability (see Patent literature No. 2, for example).

Reduction of the mean pore diameter of the PTFE microporous film to 15 nanometers or less for the purpose of achieving high-accuracy as described above also causes an increase pressure loss simultaneously. Therefore, in an actual operation, a thickness of the microporous film is reduced to a level as extremely thin as about 30 micrometers to 10 micrometers or less, and thus the microporous film is used. However, reduction of thickness of the film causes a decrease in resilience and physical strength of the film, and keeping moldability to a filter and durability in long-term use is difficult. Thus, merely densifying or achieving high-accuracy of the PTFE microporous film causes a limit. Moreover, even if achieving high-accuracy of the filter has been allowed, a problem of heat deflection under a fluid at a high temperature is not always solved, and responding to a further improvement in the filtration accuracy that is predicted from now on is difficult.

Moreover, with regard to a publicly known art for coating the surface of the microporous film with the inorganic component, the art disclosed in Patent literature No. 1 is developed by providing the film with hydrophilicity by depositing the silica gel with difficulty to drop, and uniformly and thinly on the internal surface of the pores of the microporous medium. However, an improvement in strength of the microporous medium has been difficult with the silica gel substantially aiming at facilitating to bond with moisture. Moreover, the composite film obtained by the method according to Patent literature No. 2 is developed such that an applied silicon-containing polymer suppresses a temporal decrease in gas selectivity to be developed by plasma treatment to a polymer substance. However, the composite film is difficult to obtain characteristics required in using the film as a filter in the semiconductor manufacturing field in which chemical resistance is particularly required. Furthermore, film thickness of the silicon-containing polymer to be applied should be thin also in keeping the gas permeability, and resulting in an improvement in strength required for the filter for fluid separation has been difficult.

### REFERENCE LIST

### Patent Literature

Patent literature No. 1: JP 3470153 B.

Patent literature No. 2: JP H4-053575 A.

### SUMMARY OF INVENTION

### Technical Problem

In view of such a background art, an objective of the invention is to provide a composite porous film that has both a sufficient chemical resistance and strength allowing suppression of heat deflection under a fluid at a high temperature near 120° C., and a filter using the same.

### Solution to Problem

The present inventors have diligently continued to conduct research for solving the problem, as a result, have found that a composite porous film having a constitution as described below can solve the problem, and thus have completed the invention based on the finding. The invention has constitutions from item 1 to item 10 as described below.
Item 1. A composite porous film for fluid separation, comprising a fluoropolymer resin and a SiO₂ glass.
Item 2. The composite porous film for fluid separation according to item 1, comprising a microporous film including the fluoropolymer resin, and a SiO₂ glass layer including the SiO₂ glass, wherein at least one side of a surface of the microporous film is coated with the SiO₂ glass layer.
Item 3. The composite porous film for fluid separation according to item 1 or 2, wherein a mean pore diameter of the composite porous film for fluid separation is in the range of 5 to 500 nanometers.
Item 4. The composite porous film for fluid separation according to any one of items 1 or 3, wherein the fluoropolymer resin is at least one kind selected from the group of polytetrafluoroethylene, a tetrafluoroethylene-perfluoroalkyl vinyl ether copolymer resin, a perfluoro ethylene-propylene copolymer, an ethylene-tetrafluoroethylene copolymer, polyvinylidene fluoride and polyvinyl fluoride.
Item 5. The composite porous film for fluid separation according to any one of items 1 to 4, wherein the fluoropolymer resin is polytetrafluoroethylene.
Item 6. The composite porous film for fluid separation according to any one of items 1 to 5, wherein the composite porous film for fluid separation has a flat film shape.
Item 7. The composite porous film for fluid separation according to any one of items 1 to 5, wherein the composite porous film for fluid separation has a hollow fiber film shape.
Item 8. A method for manufacturing a composite porous film for fluid separation, wherein a coating film of a silica precursor is formed at least on one side of a microporous film including a fluoropolymer resin, and then applying at least one of treatment selected from heat treatment and steam treatment to convert the silica precursor into a SiO₂ glass, and thus a SiO₂ glass layer is formed at least on one side of the microporous film, and a composite porous film coated with the SiO₂ glass is obtained.
Item 9. The method for manufacturing the composite porous film for fluid separation according to item 8, wherein the silica precursor is at least one kind selected from polysilazane and organic silazane.
Item 10. A filter, using the composite porous film for fluid separation according to any one of items 1 to 7.

### Advantageous Effects of Invention

In a composite porous film for fluid separation according to the invention, heat deflection or opening of the film under a fluid can be suppressed at a minimum. Therefore, a filter that keeps filtration accuracy and is excellent in chemical resistance and resistance to heat deflection can be prepared.

### Description of Embodiments

Hereafter, the invention will be explained in more detail.

In addition, according to the invention, percentage expressed in terms of mass is wholly similar to percentage expressed in terms of weight.

A composite porous film for fluid separation (hereinafter, occasionally also simply referred to as “composite porous film”) according to the invention is constituted of a fluoropolymer resin and a SiO₂ glass. In addition, according to the invention, a fluid means a liquid and a gas, and the composite porous film for fluid separation according to the invention can be particularly suitably used for the liquid.

The fluoropolymer resin that constitutes the composite porous film for fluid separation according to the invention can be obtained by a technique, such as emulsion polymerization using a fluorine-containing halogenated monomer as a material. Specific examples include a homopolymer using a fluorinated olefin monomer such as tetrafluoroethylene, hexafluoropropylene, vinylidene fluoride, ethylene fluoride and chlorotrifluoroethylene, a fluorinated functional monomer such as perfluoroalkyl vinyl ethers, perfluoroesters, perfluorosulfonylfluorides and perfluorodioxols, or a copolymer using at least two kinds of monomers. One example of the thus obtained fluoropolymer resin includes polytetrafluoroethylene, a tetrafluoroethylene-perfluoroalkyl vinyl ether copolymer resin (also known as perfluoroalkoxylalkane), a perfluoro ethylene-propylene copolymer, an ethylene-tetrafluoroethylene copolymer, polyvinylidene fluoride and polyvinyl fluoride. Among the fluoropolymer resins, polytetrafluoroethylene, a tetrafluoroethylene-perfluoroalkyl vinyl ether copolymer resin, a perfluoro ethylene-propylene copolymer and an ethylene-tetrafluoroethylene copolymer all having an excellent chemical resistance are particularly preferred, and polytetrafluoroethylene having the most excellent heat resistance is further preferably used. The fluoropolymer resins may be used alone or in combination with two or more kinds.

The microporous film used in the invention is not particularly limited, but can be molded from the fluoropolymer resin according to a method as described below.

First, powder including the fluoropolymer resin, and a molding auxiliary such as naphtha and mineral oil are mixed to prepare paste, and the paste is charged into an extruder to obtain an extrusion molded product in a cylindrical shape, a square column shape, a hollow shape or a sheet shape. On the occasion, an extrusion molded product may be prepared in which different fluoropolymers are laminated with each other in two or more layers by extrusion using a compound nozzle. The resultant extrusion molded product is pulled or rolled in an extrusion direction or a direction orthogonal to the extrusion direction by means of heat rolls such as calendering rolls, for example, to be formed into a hollow fiber shape or a sheet (thin plate) shape. The resultant product is stretched after removing the molding auxiliary or without removing the auxiliary, and further calcinated, when necessary, and thus a microporous film molded as a hollow fiber film or a flat film can be obtained. The thus obtained microporous film is constituted of a fibril skeleton. In a case of uniaxial stretching, a fibrous structure is formed in which fibrils are oriented in a stretching direction, and holes are formed between the fibrils. In a case of biaxial stretching, a web-shaped fibrous structure is formed in which the fibrils radially spread.

As for the SiO₂ glass that constitutes the composite porous film for fluid separation according to the invention, a silica precursor is converted into the SiO₂ glass (silica glass) by performing heat treatment or steam treatment of the silica precursor. The silica precursor is applied to the microporous film including the fluoropolymer resin, subjected to at least one of treatment selected from heat treatment and steam treatment, and the SiO₂ glass layer is formed on the microporous film, and thus the composite microporous film of the invention can be obtained. As the silica precursor, polysilazane, organic silazane and a mixture of polysilazane and organic silazane, or the like can be suitably used.

Specific examples of a method for forming the SiO₂ glass layer include a sol-gel process for converting polyorganosiloxane into the SiO₂ glass layer by a technique such as permeation and deposition, and heating, and as one process, a technique for depositing a solution obtained by allowing a hydrolytic silicon-containing organic compound to react with water to partially gelate the organic compound onto a surface of the microporous film by a technique such as application or spraying, and then allowing the solution to react with water to completely gelate the deposit, and further heating and drying the resultant gel, and thus obtaining the composite porous film, and a polysilazane process for depositing a solution mainly containing a compound of polysilazanes having a constitutional unit represented by formula (A) as described below (polysilazane solution) onto the microporous film by a technique such as application or spraying, and then converting the resultant deposit into the SiO₂ glass layer through air heating or treatment with hot water, steam or the like.

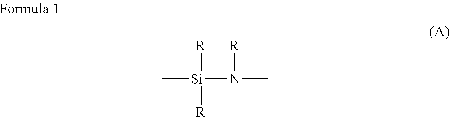

In formula (A), R each independently represents hydrogen or an alkyl group having 1 to 22 carbons.

In obtaining the composite porous film of the invention, the polysilazane process using polysilazane as the silica precursor is most preferred. The reason is that, according to the polysilazane process, the composite porous film having a high strength can be easily obtained by relatively easy progress of conversion into the SiO₂ glass layer having a dense structure, and elution of an impurity from a cross-linking agent, a catalyst residue or the like is small.

The polysilazane used in the invention can be preferably converted into the SiO₂ glass at a low temperature. Specific examples of such polysilazane include a solution containing polysilazane having a Si-H bond described in JP 2004-155834 A, silicon alkoxide-added polysilazane described in JP H5-238827 A, glycidol-added polysilazane described in JP H6-122852 A, and acetylacetonato complex-added polysilazane described in JP 3307471 B. In addition, the polysilazane solution can be obtained as “AQUAMICA (registered tradename)” made by AZ Electronic Materials SA, for example.

In the invention, as for the SiO₂ glass layer, the polysilazane solution is preferably homogeneously applied to the microporous film in a face direction also in obtaining strength under an atmosphere of 120° C. On the other hand, a suitable method is desirably selected for the microporous film in a thickness direction because a preferred case includes homogeneous solution application, or graded amount application for any purpose, respectively. In any case, while considering necessity of keeping gas permeability and liquid permeability required for the composite porous film also, the SiO₂ glass layer is necessarily formed at least on one side of the microporous film such that at least one side of the surface of the composite porous film is coated with the SiO₂ glass. If the SiO₂ glass layer partially clogs the microporous film, reduction of holes can be suppressed, and simultaneously a denser hole diameter can be obtained to allow utilization also as an unsymmetrical composite porous film.

A deposition amount of the SiO₂ glass is not particularly limited. However, the SiO₂ glass is preferably deposited in the range of 0.6 to 8.0 g/m², further preferably, in the range of 0.7 to 8.0 g/m², still further preferably, in the range of 1.0 to 6.5 g/m², particularly preferably, in the range of 1.5 to 6.5 g/m², most preferably, in the range of 1.5 to 4.0 g/m², based on a film area of the composite porous film for fluid separation. The deposition amount of the SiO₂ glass in the range of 0.6 g/m² or more is preferred because the composite porous film can obtain a sufficient resistance to heat deflection, and the deposition amount in the range of 8.0 g/m² or less is preferred because a decrease in fluid flow caused by clogging of the pores of the microporous film by the SiO₂ glass layer can be minimized. In addition, the film area of the composite porous film for fluid separation in the invention is defined as a surface area of the film in direct contact with a feed liquid. Specifically, the film area is expressed by means of an area as a square in the case of the flat film, and by means of an area of an outer surface or an inner surface in the case of the hollow fiber film.

Specific examples of a method for quantitatively confirming the deposition amount of the SiO₂ glass layer in the composite porous film include a technique for precalculating a weight of the microporous film before coating and determining the deposition amount by subtracting the weight from a weight of the composite porous film after coating, and also a technique for calcinating the composite porous film at a high temperature of several hundred degrees to decompose and remove the microporous film and determining the deposition amount from a residue, or a technique for determining the deposition amount by subtracting a weight of the microporous film after immersing the composite porous film into a chemical (fluorine chemical such as hydrofluoric acid, for example) to decompose and remove the SiO₂ glass layer. The method is obviously not limited to the exemplified methods, and the amount can also be confirmed by other techniques.

In addition, specific examples of a method for qualitatively or quantitatively confirming the thickness of the SiO₂ glass layer include a method for directly observing a cross-section of the composite porous film by means of a scanning electron microscope (SEM), and also a method for performing surface analysis of the SiO₂ glass on a surface layer of the composite porous film by a technique such as X-ray photoelectron spectroscopy, and a method for judging the thickness from an element distribution by detection of characteristic X-rays of Si. The method is obviously not limited to the exemplified methods, and the thickness can also be confirmed by other techniques.

In the invention, the mean pore diameter of the composite porous film for fluid separation is preferably in the range of 5 to 500 nanometers, further preferably, in the range of 5 to 450 nanometers, most preferably, in the range of 10 to 400 nanometers. The mean pore diameter of the composite porous film for fluid separation in the range of 5 nanometers or more is preferred because an increase in pressure loss caused by clogging during filtration can be minimized, and the mean pore diameter in the range of 500 nanometers or less is preferred because permeation of coarse impurity particles can be suppressed.

Moreover, in the invention, a strength maintenance factor represented by formula (1) as described below is preferably 40% or more for the composite porous film for fluid separation to maintain filtration accuracy even under a fluid at a high temperature near 120° C. The strength maintenance factor numerically expresses a relationship between stress needed for heat deflection and the filtration accuracy under a high temperature. If the strength maintenance factor is 40% or more, the film can be judged to have resistance to heat deflection. In addition, the strength maintenance factor of the composite porous film for fluid separation according to the invention is further preferably 60% or more, still further preferably, 80% or more, most preferably, 100% or more for practical purposes.

Strength maintenance factor (%)=CY₁₂₀ (MPa)/Y₂₃(MPa)×100 (1)

wherein Y₂₃ represents a Young's modulus, under normal temperature (23±1° C.), of the microporous film made of fluoropolymer resin, and CY₁₂₀ represents a Young's modulus, under an atmosphere of 120° C., of the composite porous film constituted of the microporous film and the SiO₂ glass layer.

The Young's modulus is expressed in terms of a flexural modulus to express how much stress is required per unit strain in an elastic range. In the invention, Young's modulus (CY₁₂₀) under an atmosphere of 120° C. is preferably 90 MPa or more, further preferably, 100 MPa or more, still further preferably, 150 MPa or more, most preferably, 200 MPa or more. Young's modulus under an atmosphere of 120° C. in the range of 90 MPa or more is preferred because a sufficient filtration accuracy can be obtained without opening the pore diameter even when the fluid at a high temperature near 120° C. is passed.

In general, the fluoropolymer resin has a high melting point and is excellent in heat resistance. On the other hand, the resin has a low heat deflection temperature (HDT: ° C., 0.45 Pa). For example, the heat deflection temperature of polytetrafluoroethylene (PTFE) is about 115° C., and HDT is lower, as compared with height of a melting point (327° C.). However, the SiO₂ glass layer formed on a PTFE microporous film suppresses the heat deflection of PTFE, and allows to minimize a change of a size of the hole part. More specifically, CY₁₂₀ as Young's modulus under an atmosphere of a high temperature (120° C.) can also be sufficiently increased. Moreover, if the strength maintenance factor under an atmosphere of 120° C. as calculated by formula (1) as described above is 40% or more, a composite porous film that is excellent in maintaining the filtration accuracy can be obtained. Furthermore, the resultant SiO₂ glass layer is excellent in any of acid resistance excluding part of chemical such as hydrofluoric acid, alkali resistance and organic solvent resistance, and the film can be used without almost preventing the chemical resistance of PTFE.

Magnitude of gradient of the deposition amount of the SiO₂ glass in the thickness direction of the composite porous film can be changed by the method for applying the polysilazane solution to the microporous film including the fluoropolymer resin. Examples of an application method are not particularly limited. Specific examples include a publicly known method including roll coating, gravure coating, blade coating, spin coating, bar coating and spray coating. The polysilazane solution is applied to the microporous film to deposit the solution, and then a solvent is evaporated by preliminary drying, and a polysilazane layer is prepared. Furthermore, the polysilazane layer is converted into the SiO₂ glass layer by a technique such as heating, immersion in hot water or exposure to steam to prepare the composite porous film. In addition, the polysilazane layer may be converted into the SiO₂ glass layer after the film is wound in a state in which the polysilazane layer is formed thereon, and then applying treatment such as heating or exposure to steam to a whole wound body.

In a step for applying the polysilazane solution, the polysilazane solution is sufficiently permeated into the microporous film. Thus, the thickness of the polysilazane layer after preliminary drying is homogenized in the thickness direction of the microporous film, and thus a composite porous film can be prepared in which the deposition amount of SiO₂ glass layer is homogeneous in the thickness direction or a change in the deposition amount in the thickness direction is small. Specific examples include a method for adjusting a polysilazane concentration in the range of 5 to 20% by mass and using the solution by selecting the blade coating process as the application method.

On the other hand, in the step for applying the polysilazane solution, permeation of the polysilazane solution into the microporous film can be suppressed by gently spraying the polysilazane solution onto the microporous film. Thus, a composite porous film can be prepared in which the SiO₂ glass layer is deposited with an uneven distribution only on a surface in one side of the microporous film. Specific examples include a method for adjusting a polysilazane concentration in the range of 0.5 to 5% by mass to be jetted together with a nitrogen gas from a nozzle for spraying mist to form mist having a particle diameter in the range of about 5 to 10 micrometers, and accumulate the mist by allowing the microporous film to stand under an atmosphere of the mist.

Moreover, in a process for depositing the polysilazane solution, performance as the filter can be further improved by adding a suitable filler to the polysilazane solution within the range in which the chemical resistance or resistance to heat deflection of the composite porous film is not adversely affected. Specific examples of the filler include zinc oxide, titanium dioxide, barium titanate, barium carbonate, barium sulfate, zirconium oxide, zirconium silicate, alumina, magnesium oxide and silica, and also particulates of silicon carbide, silicon nitride and carbon. The carbon includes graphite carbon particulates, and also particulates of activated carbon and particulates constituted of a form of carbon nanotubes. At least one kind of the fillers deposits onto the microporous film together with polysilazane to be strongly fixed into the SiO₂ glass layer. Thus, the composite porous film without dropping can be obtained.

The concentration of the filler in the polysilazane solution is ordinarily in the range of 0 to 20% by mass, preferably, in the range of 0 to 10% by mass. When the concentration is in such a range, the performance as the filter can be further improved.

The thus obtained composite porous film satisfies both densification and strength of the film (resilience). Therefore, the composite porous film can be easily processed into the filter, and thus can provide the filter for the liquid or gas, allowing to keep the chemical resistance and also the filtration accuracy even when a fluid at a heat deflection temperature or higher is filtered. Furthermore, the fluoropolymer as a raw material of the microporous film is physically reinforced. Thus, damage caused when cleaning and reusing the filter can be suppressed to a minimum.

### EXAMPLES

In the following, the invention will be explained in detail by way of Examples and Comparative Example, but the invention is in no way limited by the Examples and the Comparative Example. In addition, in each Example and Comparative Example, physical properties were evaluated according to methods as shown below.

### (Young's Modulus)

Autograph AG-10TD (model) (made by Shimadzu Corporation) was used as a tensile tester. Based on tensile testing of a thin plastic sheeting as defined in ASTM D882 (2002), a load and an elongation rate curve (stress-strain curve) were determined, and Young's modulus was determined from a rising gradient. A test specimen having a dimension of 120 mm×10 mm was prepared for a composite porous film which thickness was measured in advance, and fixed at an interchuck distance of 50 mm, and then the stress-strain curve was prepared at a tensile speed of 5 mm/min. A load at 1% elongation was determined from the rising gradient, and a value obtained by dividing the load with a cross-section was determined as Young's modulus (unit: MPa). When the testing was carried out under heating conditions, a circumference of a chuck was covered with a constant-temperature layer, and then Young's modulus was measured under predetermined temperature conditions in a similar manner. Young's modulus was measured at normal temperature (23±1° C.) and at 120° C.

### (Strength Maintenance Factor)

A strength maintenance factor was determined according to formula (1) as described below.

Strength maintenance factor (%)=CY₁₂₀(MPa)/Y₂₃(MPa)×100 (1)

wherein Y₂₃ represents Young's modulus, under normal temperature (23±1° C.), of a microporous film made of fluoropolymer resin, and CY₁₂₀ represents Young's modulus, under an atmosphere of 120° C., of a composite porous film constituted of the microporous film and a SiO₂ glass layer.

### (Mean Pore Diameter)

As an automatic pore diameter distribution measuring instrument, a measuring apparatus as described below was used.

Apparatus 1: “Capillary Flow Porometer CFP-1200AEX” made by PMI.

Apparatus 2: “Nano Perm Porometer TNF-WH-M” made by SEIKA Corporation.

A mean pore diameter was determined according to a bubble point method (ASTM F316-86, JIS K3832). A mean pore diameter in the range of 50 nm or more was determined as a mean flow diameter using Apparatus 1. A mean pore diameter in the range less than 50 nm was determined by using Apparatus 2, and applying a Kelvin equation to capillary condensation of hexane.

In Examples and Comparative Example as described below, a polysilazane solution shown in Table 1 was used and a concentration was appropriately adjusted as the polysilazane solution being a raw material of a SiO₂ glass.

TABLE 1

| | AQUAMICA | AQUAMICA | |
|---|---|---|---|
| Product name | NL120A | NAX120 | MHPS-40DB |
| Silica precursor | Polysilazane | Polysilazane | Organic |
| | | | polysilazane |
| Silica transition | 80 to 300° C. | Normal temperature | No transition as |
| temperature | | to 150° C. | a single silica |
| Catalyst | Palladium-based | Amine-based | Not added |
| Solvent | Dibutyl ether | Dibutyl ether | Hexane |
| Color tone | Brownish red | Transparent | Transparent |

### Example 1

Onto a flat glass plate, POREFLON HP-045-30 (trade name) (made by Sumitomo Electric Fine Polymer, Inc., a nominal mean pore diameter: 0.45 micrometer) being a microporous film of fluoropolymer cut into 21 cm×30 cm (a film area: 0.063 m², more specifically) was fixed, 2.3 g of a solution prepared by diluting “AQUAMICA (registered tradename) Catalog No. NL120A” (polysilazane solution) made by AZ Electronic Materials SA with dry dibutyl ether and adjusting a polysilazane concentration at 10% by mass was added dropwise as a solution of a silica precursor, and then coating treatment was quickly performed using a bar coater made by Daiichi Rika Co., Ltd. After a solvent evaporated, the resultant film was removed from the glass plate, and put in an oven kept at a humidified atmosphere, subjected to heat treatment at 150° C. for 1 hour, and thus a composite porous film was prepared. A deposition amount (unit: g/m²) of a SiO₂ glass was calculated from the weight before and after coating.

### Example 2

A composite porous film was prepared in a manner similar to Example 1 except that a solution prepared by diluting “AQUAMICA (registered tradename) Catalog No. NAX120” (polysilazane solution) made by AZ Electronic Materials SA with dry dibutyl ether and adjusting a polysilazane concentration at 10% by mass was used as a solution of a silica precursor.

### Example 3

A composite porous film was prepared in a manner similar to Example 1 except that a solution prepared using “AQUAMICA (registered tradename) Catalog No. NL120A” (polysilazane solution) made by AZ Electronic Materials SA to be diluted with dry dibutyl ether and adjusted at 20% by mass in a polysilazane concentration was used as a solution of a silica precursor.

### Example 4

A composite porous film was prepared in a manner similar to Example 1 except that a solution prepared by diluting “AQUAMICA (registered tradename) Catalog No. NAX120” (polysilazane solution) made by AZ Electronic Materials SA with dry dibutyl ether and adjusting a polysilazane concentration at 20% by mass was used as a solution of a silica precursor.

### Example 5

A composite porous film was prepared in a manner similar to Example 1 except that a solution prepared by diluting “AQUAMICA (registered tradename) Catalog No. NL120A” (polysilazane solution) made by AZ Electronic Materials SA with dry dibutyl ether and adjusting a polysilazane concentration at 5% by mass was used as a solution of a silica precursor.

### Example 6

A composite porous film was prepared in a manner similar to Example 1 except that a solution prepared by diluting “AQUAMICA (registered tradename) Catalog No. NAX120” (polysilazane solution) made by AZ Electronic Materials SA with dry dibutyl ether and adjusting a polysilazane concentration at 5% by mass was used as a solution of a silica precursor.

### Example 7

A composite porous film was prepared in a manner similar to Example 1 except that a solution prepared by diluting “AQUAMICA (registered tradename) Catalog No. NL120A” (polysilazane solution) made by AZ Electronic Materials SA with dry dibutyl ether and adjusting a polysilazane concentration at 2% by mass was used as a solution of a silica precursor.

### Example 8

A composite porous film was prepared in a manner similar to Example 1 except that a solution prepared by diluting “AQUAMICA (registered tradename) Catalog No. NAX120” (polysilazane solution) made by AZ Electronic Materials SA with dry dibutyl ether and adjusting a polysilazane concentration at 1% by mass was used as a solution of a silica precursor.

### Example 9

A composite porous film was prepared in a manner similar to Example 1 except that a solution prepared by adjusting each concentration of an organic silazane “Catalog No. MHPS-40DB” and “AQUAMICA (registered tradename) Catalog No. NAX120” both made by AZ Electronic Materials SA at 10% by mass and mixing the solutions at a mass ratio of 1 to 1 and adjusting each concentration at 5% by mass was used as a solution of a silica precursor.

### Example 10

Onto a flat glass plate, POREFLON HP-045-30 (trade name) (made by Sumitomo Electric Fine Polymer, Inc., a nominal mean pore diameter: 0.45 micrometer) being a microporous film of fluoropolymer cut into 21 cm×30 cm (film area: 0.063 m², more specifically) was fixed. On the other hand, a solution prepared by adjusting a concentration of “AQUAMICA (registered tradename), Catalog No. NL120A” (polysilazane solution) made by AZ Electronic Materials SA at 20% by mass was used as a solution of a silica precursor. The solution was sprayed with a nitrogen gas to be a droplet having a particle diameter of 10 microns, and a microporous film fixed on the glass place was placed under an atmosphere thereof for 10 minutes to allow a precipitating droplet of the polysilazane solution to accumulate thereon. After a solvent evaporated, the resultant film was removed from the glass plate, and put in an oven kept at a humidified atmosphere, subjected to heat treatment at 150° C. for 1 hour, and thus a composite porous film was prepared.

### Example 11

A composite porous film was prepared in a manner similar to Example 10 except that a solution prepared by adjusting a concentration of “AQUAMICA (registered tradename) Catalog No. NL120A” (polysilazane solution) made by AZ Electronic Materials SA at 5% by mass was used as a solution of a silica precursor, and the polysilazane solution was sprayed with a nitrogen gas to be a droplet having a particle diameter of 100 microns.

### Example 12

A solution prepared by adjusting a concentration of “AQUAMICA (registered tradename) Catalog No. NL120A” (polysilazane solution) made by AZ Electronic Materials SA at 5% by mass was used as a solution of a silica precursor. On the other hand, on POREFLON HP-045-30 (trade name) (made by Sumitomo Electric Fine Polymer, Inc., a nominal mean pore diameter: 0.45 micrometer) being a long microporous film of fluoropolymer having a 21 cm wide and 1 m long dimension, roll coating of the polysilazane solution was performed at a speed of lm per minute, and a solvent was evaporate. The resultant film was put in an oven kept at a humidified atmosphere, subjected to heat treatment at 150° C. for 1 hour, and thus a composite porous film was prepared.

### Comparative Example 1

A microporous film of fluoropolymer obtained without treatment with a solution of a silica precursor in Example 1 was put in an oven kept at a humidified atmosphere, subjected to heat treatment at 150° C. for 1 hour, and thus a composite porous film was prepared.

Based on the evaluation methods described above, thickness, a mean pore diameter, Young's modulus (normal temperature and 120° C.), and a strength maintenance factor were measured on the composite porous films according to Examples 1 to 12 and Comparative Example 1. The results are shown in Table 2 and Table 3.

TABLE 2

| | | Example 1 | Example 2 | Example 3 | Example 4 | Example 5 | Example 6 | Example 7 |
|---|---|---|---|---|---|---|---|---|
| Fluoropolymer | Product | HP-045-30 | | | | | | |
| microporous | Name | | | | | | | |
| film | Thickness | 15 | | | | | | |
| | (μm) | | | | | | | |
| | Mean pore | 320 | | | | | | |
| | diameter | | | | | | | |
| | (nm) | | | | | | | |
| | Young's | 230 | | | | | | |
| | modulus | | | | | | | |
| | Y₂₃ (MPa) | | | | | | | |
| Silica precursor | Product | NL120A | NAX120 | NL120A | NAX120 | NL120A | NAX120 | NL120A |
| solution | Name | | | | | | | |
| | Concentration | 10 | 10 | 20 | 20 | 5 | 5 | 5 |
| | (% | | | | | | | |
| | by mass) | | | | | | | |
| | SiO2 glass | 3 | 3.5 | 6.1 | 6.2 | 1.5 | 2 | 0.6 |
| | deposition | | | | | | | |
| | amount | | | | | | | |
| | (g/m2) | | | | | | | |
| | Application | Bar | Bar | Bar | Bar | Bar | Bar | Bar |
| | method | coating | coating | coating | coating | coating | coating | coating |
| Physical | Thickness | 17 | 17 | 17 | 18 | 16 | 16 | 15 |
| properties of | (μm) | | | | | | | |
| microporous | Mean pore | 300 | 90 | 280 | 60 | 310 | 310 | 320 |
| film for liquid | diameter | | | | | | | |
| separation | (nm) | | | | | | | |
| | Young's | 500 | 750 | 1,000 | 1,200 | 350 | 620 | 300 |
| | modulus | | | | | | | |
| | Y₂₃ | | | | | | | |
| | (normal | | | | | | | |
| | temperature: | | | | | | | |
| | MPa) | | | | | | | |
| | Young's | 165 | 330 | 370 | 480 | 145 | 225 | 95 |
| | modulus | | | | | | | |
| | Y₁₂₀ (MPa) | | | | | | | |
| | Strength | 72% | 143% | 160% | 209% | 63% | 98% | 41% |
| | maintenance | | | | | | | |
| | factor | | | | | | | |
| | CY₁₂₀/CY₂₃ | | | | | | | |

TABLE 3

| | | | | Example | Example | | Comparative |
|---|---|---|---|---|---|---|---|
| | | Example 8 | Example 9 | 10 | 11 | Example 12 | Example 1 |
| Fluoropolymer | Product | HP-045-30 | | | | | |
| microporous | Name | | | | | | |
| film | Thickness | 15 | | | | | |
| | (μm) | | | | | | |
| | Mean pore | 320 | | | | | |
| | diameter | | | | | | |
| | (nm) | | | | | | |
| | Young's | 230 | | | | | |
| | modulus | | | | | | |
| | Y₂₃ (MPa) | | | | | | |
| Silica precursor | Product | NAX120 | MHPS-40DB/ | NL120A | NL120A | NL120A | — |
| solution | Name | | NAX120 | | | | |
| | Concentration | 1 | 5 + 5 | 20 | 5 | 5 | — |
| | (% | | | | | | |
| | by mass) | | | | | | |
| | SiO₂ glass | 0.6 | 3.1 | 3.1 | 3 | 3 | — |
| | deposition | | | | | | |
| | amount | | | | | | |
| | (g/m²) | | | | | | |
| | Application | Bar | Bar coating | Spraying | Spraying | Roll | — |
| | method | coating | | | | coating | |
| Physical | Thickness | 15 | 16 | 18 | 18 | 17 | 15 |
| properties of | (μm) | | | | | | |
| microporous | Mean pore | 310 | 300 | 300 | 310 | 300 | 320 |
| film for liquid | diameter | | | | | | |
| separation | (nm) | | | | | | |
| | Young's | 300 | 640 | 600 | 800 | 360 | 230 |
| | modulus | | | | | | |
| | Y₂₃ | | | | | | |
| | (normal | | | | | | |
| | temperature: | | | | | | |
| | MPa) | | | | | | |
| | Young's | 105 | 380 | 290 | 305 | 170 | 70 |
| | modulus | | | | | | |
| | Y₁₂₀ (MPa) | | | | | | |
| | Strength | 46% | 165% | 126% | 133% | 74% | 30% (*) |
| | maintenance | | | | | | |
| | factor | | | | | | |
| | CY₁₂₀/CY₂₃ | | | | | | |

(*) The strength maintenance factor in Comparative Example 1 is expressed in terms of a ratio of Young's modulus at 120° C. (MPa) to CY₂₃ of a fluoropolymer microporous film.

The results in Table 2 and Table 3 show that the microporous films according to Examples 1 to 12 have a higher Young's modulus at 120° C., and a higher strength maintenance factor, as compared with the microporous film according to Comparative Example 1. Therefore, the results show that the microporous films according to Examples 1 to 12 are excellent in resistance to heat deflection without an influence on deformation, opening or the like by heat even under a fluid at a high temperature near 120° C. Moreover, the results show that the deposition amount of the SiO₂ glass in the range of 1.5 g/m² or more in Examples 1 to 6, and 9 to 12 provides a higher Young's modulus at 120° C. and a higher strength maintenance factor to produce a composite porous film having an excellent resistance to heat deflection also for practical purposes.

Although the invention has been explained in detail and with reference to particular embodiments, numerous changes and modifications can be resorted to those skilled in the art without departing from the spirit and scope of the invention. The present application is based on Japanese patent application on Jun. 18, 2010 (Application for Patent 2010-139688), which is incorporated herein by reference.

### INDUSTRIAL APPLICABILITY

A composite porous film of the invention has 40% or more of strength maintenance factor under an atmosphere of 120° C. Thus, an excellent filter that can keep filtration accuracy even by circulating a fluid at a high temperature exceeding a heat deflection temperature of fluoropolymer, particularly, PTEE, and has an excellent chemical resistance and an excellent resistance to heat deflection that are comparable to PTTE can be prepared. Therefore, the filter can be particularly effectively utilized in an application to a pharmaceutical or food in which a high-temperature sterilization step is essential, an application to a semiconductor cleaning step in which a strong decomposition is needed, or the like.

1. A composite porous film for fluid separation, comprising a fluoropolymer resin and a SiO₂ glass.

2. The composite porous film for fluid separation according to claim 1, comprising a microporous film including the fluoropolymer resin, and a SiO₂ glass layer including the SiO₂ glass, wherein at least one side of a surface of the microporous film is coated with the SiO₂ glass layer.

3. The composite porous film for fluid separation according to claim 1, wherein a mean pore diameter of the composite porous film for fluid separation is in the range of 5 to 500 nanometers.

4. The composite porous film for fluid separation according to claim 1, wherein the fluoropolymer resin is at least one kind selected from the group of polytetrafluoroethylene, a tetrafluoroethylene-perfluoroalkyl vinyl ether copolymer resin, a perfluoro ethylene-propylene copolymer, an ethylene-tetrafluoroethylene copolymer, polyvinylidene fluoride and polyvinyl fluoride.

5. The composite porous film for fluid separation according to claim 1, wherein the fluoropolymer resin is polytetrafluoroethylene.

6. The composite porous film for fluid separation according to claim 1, wherein the composite porous film for fluid separation has a flat film shape.

7. The composite porous film for fluid separation according to claim 1, wherein the composite porous film for fluid separation has a hollow fiber film shape.

8. A method for manufacturing a composite porous film for fluid separation, wherein a coating film of a silica precursor is formed at least on one side of a microporous film including a fluoropolymer resin, and then applying at least one of treatment selected from heat treatment and steam treatment to convert the silica precursor into a SiO₂ glass, and thus a SiO₂ glass layer is formed at least on one side of the microporous film, and a composite porous film coated with the SiO₂ glass is obtained.

9. The method for manufacturing the composite porous film for fluid separation according to claim 8, wherein the silica precursor is at least one kind selected from polysilazane and organic silazane.

10. A filter, using the composite porous film for fluid separation according to claim 1.
